(19) United States
(12) Patent Application Publication
(10) Pub. No.: US 2026/0368628 A1
(43) Pub. Date: Nov. 19, 2026

(54) MACHINE LEARNING MODEL PIPELINE FOR AUTOMATED SOLUTION GENERATION TO ANOMALOUS SIGNAL DETECTION

(71) Applicant: PAYPAL, INC., San Jose, CA (US)

(72) Inventors: Yue Qian, Shanghai (CN); Zexin Zhang, Shanghai (CN); Zhengjie Xi, Shanghai (CN); Xiaomin Lu, Shanghai (CN); Chengwen Gao, Shanghai (CN)

(21) Appl. No.: 19/211,072

(22) Filed: May 16, 2025

(51) Int. Cl. G06N 20/00

(52) U.S. Cl. CPC G06N 20/00

(57) ABSTRACT

Computer security improvements relating to anomalous signal detection using a machine learning pipeline for automated solution generation are disclosed. A service provider may utilize a framework having computing operations for automated machine learning (ML) solution generation using unannotated data. In this regard, the service provider may provide an ML modeling platform where ML models may be automatically trained. Alert signals may be detected by an initial alert model, which does not include annotating those signals with machine annotations in place of human review. Signals may be segmented by features of a population, and once segmented, the signals may be more deeply analyzed for a root cause and riskiness. Those that are risky may be used for training an clustering model that identified whether further signals are similar to a cluster of risky signals, and if so, may automate solution execution to minimize risk.

### TECHNICAL FIELD

The present application generally relates to artificial intelligence (AI) systems, and more particularly to a pipeline for machine learning (ML) modeling that generates ML solutions to anomalous signals through automated training data generation and ML signal evaluation.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. However, as hackers and other malicious users or entities become more sophisticated, they may perform different computing attacks and other malicious conduct to compromise these communications. For example, attacking entities may use scripted bots that replay an attack numerous times and/or with different endpoints including employees, internal agents, and automated chatbots or systems. Other computing attacks may seek to compromise and/or use compromised personal and/or financial information to perpetrate fraud. Without accurately and quickly identifying these attacks and performing remedial actions, the service provider may risk fraud, loss, and decreased customer trust or satisfaction.

When conducting transactions with payment cards, such as debit and credit cards, there are significant risks of fraud when processing the transaction electronically, especially with online digital transactions where identity becomes more difficult to assess and detect. As such, transaction processors and other online service providers have implemented risk mitigation pipelines when processing electronic transactions. However, these suffer from a few major drawbacks and vulnerabilities. First, machine learning (ML) solutions require human efforts to detect fraudsters and/or fraudulent activities and transactions, build ML models and detection systems, and test, summarize, and deploy models after building. This requires significant manual efforts and is time-consuming. Further, the solutions often require supervised learning, which is highly dependent on tagging bad, fraudulent, or malicious activities. This tagging process may take months to fully mature a training data set, which introduces significant delay. This delay may be significant enough to miss trends and/or allow fraud, which may cause significant loss. As such, there is need for an effective, efficient, and automated computing solution to generate ML training data sets and train models in an unsupervised manner so that ML solutions for risk and fraud may be deployed quickly and responsively to new, incoming, and ongoing risks and fraud.

### BRIEF DESCRIPTION OF THE DRAWINGS

FIG. 1 is a block diagram of a networked system suitable for implementing the processes described herein, according to an embodiment;

FIGS. 2A and 2B are exemplary diagrams of a system pipeline implementing an auto-alert, auto-root cause analysis, auto-solution and/or auto-action or mass action, and auto-summary modules, according to an embodiment;

FIGS. 3A and 3B are exemplary diagrams of data and operations used to process the data of the auto-alert, auto-root cause analysis, and auto-summary modules, according to an embodiment;

FIG. 4 is a flowchart for an anomalous signal detection using a machine learning pipeline for automated solution generation, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an anomalous signal detection using a machine learning pipeline for automated solution generation. Systems suitable for practicing methods of the present disclosure are also provided. Note that while various examples, structures, techniques, etc. may be described with respect to a service provider in this specification, these structures, techniques, etc. are generalizable and are applicable to any entity that implements artificial intelligence (AI) training data generation and/or model training, for example, for machine learning (ML) models for anomalous signal processing and evaluation, according to various embodiments.

In network communications including interactions between online platforms and systems of service providers and client devices of end users, service providers may provide computing services to users and other entities through computing architectures. Such provision of services and corresponding computing architectures may face different types of computing attacks coming from malicious users and sources over a network. For example, a malicious actor may initiate a computing attack on the computing environment of the service provider that may compromise services (e.g., electronic transaction processing services) and/or expose data (e.g., personally identifiable information (PII) and/or funding source information) to the malicious actor. Computing attacks may be executed through automated computing bots or operations, such as executable scripts and bots that may quickly repeat computing attacks with different endpoints and/or internal users, employees, agents, and the like. Further, with the advent of large language models (LLMs) and other generative AI systems, creating scripts, messages, text, emails, and other communications that may be personalized and targeted while generated automatically has become faster and more sophisticated, leading to more numerous and effective attacks. These computing attacks may lead to fraud and loss by the service provider. Shell scripts may also automate other processes and operations, including program or application executables that automate execution of scripts for social engineering attacks.

To better detect fraud, fraudulent transactions and/or accounts used by these bad actors and bots may be identified and signals for such transactions, accounts, and the like may be used to train AI models and systems, such as ML models for risk and fraud detection. Conventionally, this may require specific generation of training data, which is annotated and requires human oversight, tagging, annotation, and/or review for maturation into proper training data sets. As a result, current systems may not identify an attack in sufficient time to address the attack, and due to the manual component, extensive resources may be used, and predictions may be prone to error.

As such, according to various embodiments, an online transaction processor or another online service provider may implement a security and fraud detection system for fraud and other malicious activities that automates processes for tagging transactions, accounts, or other users, entities, activities, or the like having anomalous signals, and trains an ML model automatically and with no or little human intervention.

For example, to assist in preventing or minimizing these computing attacks and other abuses, a service provider, in various embodiments, may utilize an ML pipeline and framework with their computing systems and architecture that may identify, aggregate, and/or generate training data sets, which may then be used for automated ML model training and summarization. Conventionally, each ML model is dependent on the tagging of bad transactions. Therefore, the ML models may suffer from inaccuracy due to poor tagging, old data, and changes in trends. Further, since tagging requires time, solutions are not immediately deployable. As such, this automated end-to-end pipeline provides a solution to such problems with existing risk models by utilizing a multi-component and modular design that implements unsupervised machine learning (ML) models with generative artificial intelligence (AI).

This pipeline uses machine learning models, deep learning models (e.g., neural networks (NNs) and/or deep NNs (DNNs)), generative AIs (e.g., LLMs), and the like to automate the processes for training data set acquisition and determination, with risk model training and summarization in an automated manner and with no or minimal human efforts. The outcome is a precise ML model usable for risk analysis and/or detection with real-time risk threats and activities, such as in a live computing environment. The pipeline utilizes an auto-alert module, an auto-RCA (root cause analysis) module, an auto-solution module, a mass action module, and an auto-summary module. The auto-alert module consolidates alerts from multiple sources and provides fluid segmentation of alerts depending on categorization so that trends can be detected in real-time per categorization. Fluid segmentation is described in further detail herein but generally corresponds to a segmentation process or procedure by which a data set, such as a population of users, data records, signals, or the like, may be iteratively segmented until a population size, as measured numerically or by percentage, of one of the segments, or the population size of the segment taken from an overall population, meets a preset, desired, threshold, cutoff, or minimum/maximum size. As such, the auto-alert module may utilize a fluid segmentation method with near real-time (NRT) fraud detection from multiple alert sources. The alerts may be generated based on anomalous signals, and may include risk activities, such as fraud, account takeovers (ATOs), and other types of risky, unauthorized, suspicious, or anomalous behaviors.

The auto-RCA module utilizes a novel unsupervised learning algorithm/model to determine riskiness of the alerts and classify or score those alerts. For example, a fully automated RCA process may leverage unsupervised learning through a Fraud Early Notification and Counter Engine (FENCE). As such, no bad tags of data are needed, and the training data from the auto-alert module may be used without tagging, annotations by data scientists or other users, and other manual efforts. The auto-solution module utilizes an algorithm to generate a solution (e.g., risk rule or model for handling the risky transactions associated with the alerts). The auto-solution module may incorporate a Near Real-Time Anomaly Detection Solution with Unsupervised LearnIng MethoDs (RAPID) algorithm that may generate a solution automatically and use unsupervised ML training or other training that does not require manual efforts to configure and train each model. Unsupervised training may utilize training data sets, data records, or other training information that is unlabeled, or does not have a corresponding label or identifier used to classify each data signal or other record that has been attached, affixed to, connected with, or otherwise provided by and/or based on human review or a human review process and reviewer. Instead, unsupervised learning algorithms and training may search for and identify patterns, groupings, and relationships within the training data itself without the training data being labeled and the computer or another machine processor being told what to look for and/or patterns, groupings, or relationships that exist.

With the auto-solution module, unsupervised learning may therefore be utilized to learn “without human annotation” and based on a machines own capabilities for pattern recognition and the like. However, since labels may be inferred, predicted, or intelligently determined by the auto-RCA module, supervised learning algorithms may be used in a “semi-supervised” manner where human annotators are not required or used to labeling and/or tagging data, but instead the computer processor or other machine may perform the annotating in a human-like manner that provides labels or tags that identify distinct groups, characteristics, relationships, and the like. Further, human reviewers may also be utilized when necessary to provide additional review and/or insight to automatically generated training data and data labels for signals or other data records, including semi-autonomous systems that may still utilize a human review for finalization of training data (e.g., a human-in-the-loop process that is semi-automated). In this regard, the auto-solution module may utilize the RAPID algorithm to generate ML models and/or other AI models (e.g., DNNs, rule-based engines, clustering models, decision trees, etc.) for risk analysis and other ML inferences, scores, or predictions.

The solution may therefore be generated for live deployment and real-time decision-making and processing in a live computing environment. The mass action module provides group review to link fraudsters and extend the solution, if needed. For example, linking between fraudsters may be explored and utilized to further expand the ML model for additional risk analysis and/or detection purposes. For example, a group review of fraudsters and/or linked fraudsters may be performed, as well as a backend process to explore linking between identified fraudsters and expand model parameters or features, as well as coverage, based on those linked fraudsters.

To provide for oversight and review of the training data preparation and model training performed by the system, the auto-summary module utilizes a generative AI to summarize the alerts and solutions for review by a fraud team. The auto-summary module may utilize an LLM or other generative AI with language capabilities to summarize each step of the pipeline, from the training data collection and generation as a training data set for unsupervised learning, to the determination of riskiness of different transactions or other activities and events, as well as the model training and link exploration. The summary generated may provide information regarding the results obtained at each step of the pipeline, thereby enabling a data scientist or other reviewer to understand the model training and deployment.

As such, an ML pipeline, which may correspond to a deep learning pipeline and framework, may employ multiple ML models, deep learning models, or the like that may be trained for different components used for anomalous signal detection, riskiness prediction of the signals, and auto-solution generation. This may be done to preemptively generate training data without requiring human annotations, and train a model to detect the anomalous signals, such as fraudulent transactions or transaction requests, prior to a human providing manually annotated training data to a model training program to train a similar ML model. This preemptive approach, which provides faster and preemptive fraud detection, significantly departs from the conventional reactive methods to ML model training and implementation in detection systems, such as risk and fraud detection systems. As such, the ML pipeline may provide faster and more accurate fraud detection for ongoing fraud, anomalous transactions, and other risk scenarios and/or computing attacks by implementing solutions as the anomalous signals occur and are detected. The pipeline may provide fraud detection through recognizing ongoing frauds and training ML models in real-time, faster and more accurately than human methods and efforts can train models. This use and improvement of technology underscores the improvements provided to the technical problems with identification of risk, fraud, and other computing attacks as they occur, and implementing accurate and timely detection and prevention measures.

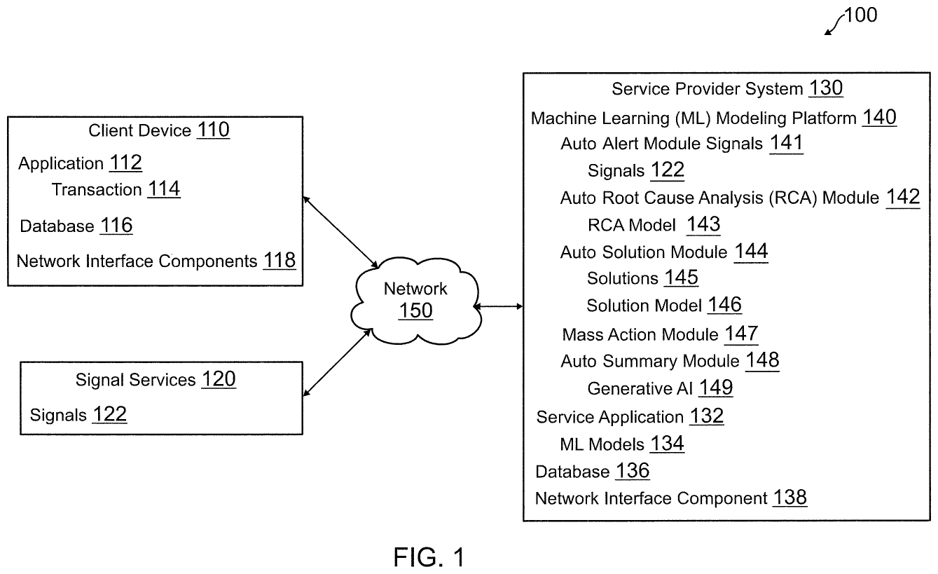

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110, signal sources 120, and a service provider system 130 in communication over a network 150. Client device 110 may be utilized by a user, such as a customer of service provider system 130, to engage in activities with other computing devices, servers, and systems over network 150, including those associated with communications in one or more communication channels, such as a service channel or assistance channel. Service provider system 130 may provide various data, operations, and other functions over network 150 to provide services to client device 110 and/or other devices of users, which may include electronic transaction processing. In this regard, client device 110 may utilize an account to engage in communications, which may be processed by service provider system 130 to identify fraud and other illegal, illicit, or unauthorized activities that may be associated with social engineering attacks or other computing attacks.

Client device 110, signal sources 120, and service provider system 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device of a customer, fraudulent actor, and/or other user associated with one or more uses of the computing services and/or digital products of service provider system 130. Client device 110 may utilize appropriate hardware and software configured for wired and/or wireless communication with service provider system 130. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user over network 150, which may include accessing and/or interacting with service provider system 130, for example, to process a transaction 114, such as a payment or transfer to another user, entity, and/or account. In this regard, application 112 may correspond to a software application, browser, or the like that may utilized by a user of client device 110 to access a website or user interface provided by service provider system 130 and engage in one or more activities including transmitting, providing, and/or approving submission of a request to process transaction 114. Transaction 114 may be analyzed by service provider system 130 for riskiness and/or potential for fraud, which may be performed when generating training data for ML model training and/or performing inferencing, such as risk and/or fraud prediction and detection, using an ML model trained using the systems and processes discussed herein. As such, application 112 may be used to provide, engage in, and/or transmit transaction 114 via one or more communications, messages, services, and/or channels of service provider system 130. Transaction 114 may be associated with one or more accounts accessed and/or used through application 112 and may therefore be linked to an account, which may have corresponding account data include assets and/or other data features from account use.

Transaction 114 may include content, such as a message including text, media (e.g., audio, video, image, etc.), and/or other information associated with one or more products, services, or other items to be purchases and/or paid for using an account and/or payment instrument. In some embodiments, transaction 114 may include and/or be associated with contact information, a financial account number, a user identification, a device identifier, or other information. Transaction 114 may also be associated with account data, which may be processed by service provider system 130 during electronic transaction and/or payment processing. When using application 112, a bad actor may utilize application 112 and/or engage in transaction 114 to conduct fraud via the computing services and/or digital products of service provider system 130. As such, service provider system 130 may process transaction 114 for identification of fraud using the ML model training and deployment pipeline discussed herein. However, where client device 110 is not used by a bad actor, a valid user may also use application 112 and engage in transaction processing of transaction 114, which may be nonfraudulent and authorized using the same or similar ML model pipeline and/or trained ML model.

To request or process transaction 114, application 112 may interact with service provider system 130, such as through interfacing with communication channels, applications, services, agents, and/or bots corresponding to service applications 132 through one or more application programming interfaces (APIs) and/or API calls that may be exchanged including requests and responses. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information (e.g., a website for a merchant), presenting the website information to the user, and/or communicating information to the website including navigating between webpages to login to accounts, process transactions, and/or otherwise utilize computing services.

However, in other embodiments, application 112 may include a dedicated software application of service provider system 130 or other entity (e.g., a merchant) resident on client device 110 (e.g., a mobile application on a mobile device), which may be configured to view and utilize data via user interfaces (e.g., applications interfaces displayable by a graphical user interface (GUI) associated with application 112) and request execution of computing operations for processing transaction 114 when utilizing service applications 112 of service provider system 130. Application 112 may provide one or more of user interfaces, for example, via GUIs presented using an output display device of client device 110, to enable the user associated with client device 110 to utilize computing services, platforms, and applications of service provider server with accounts, which may request execution of computing operations through user interface commands and other user inputs. In some embodiments, the GUI, when viewed by a data scientist, administrator, or the like that may be accessing different resources and digital platforms for ML model training, may display and/or provide information regarding ML model training, a summary of ML model training, and other information that may be determined by service provider system 130 from model training.

Application 112 may provide transaction processing, such as through a user interface enabling the user to enter and/or view transaction 114 for processing. Transaction 114 may be generated by application 112 using a service provider platform or website, merchant marketplace, or by performing peer-to-peer transfers and payments via service provider system 130 in conjunction with another account and/or computing device, which may link accounts and/or account data in a network of users. Application 112 may access accounts and view and/or utilize account information, user financial information, and/or transaction histories. In some embodiments, different services may be provided by service provider system 130 via application 112 including social networking, messaging, media posting or sharing, microblogging, data browsing and searching, online shopping, and other services available through service provider system 130. Thus, application 112 may also correspond to different service applications and the like that are associated with service provider system 130.

Client device 110 may further include or have access to database 116, which may correspond to different types of data storage and components including cloud computing storage nodes, remote data stores and database systems, distributed database systems over network 150, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 130.

Client device 110 includes at least one network interface component 118 adapted to communicate with service provider system 130 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Signal sources 120 may correspond to different sources of signals 122, such as data signals that may be detected, monitored and/or tracked, and may further be analyzed for anomalous pattern detection and model training data generation. In this regard, signal sources 120 may include client device 110 and/or may correspond to other devices, servers, and/or endpoints that may provide, generate, request processing of, and/or process signals 122. In some embodiments, signals 122 may include similar transactions and/or transaction data to transaction 114 from application 112 on client device 110. However, where signals 122 correspond to other data analyzed for anomalous signals, such as communications, messages, user activities and/or behaviors, device activities and/or behaviors, device fingerprints, navigation data, data indicative of human or automation use or interactions, or any other data signal that may be of interest for ML model detection, such data signals may be designated for analysis and anomaly detection by service provider system 130. As such, signals 122 may correspond to any data, transmitted over network 150, that may be analyzed by service provider system 130 using an anomalous signal detection for training data generation. Signals 122, and in particular, anomalous signals from signals 122, may be used to ML model training using the ML model training and deployment pipeline discussed herein for automated solution generation.

Service provider system 130 may be maintained, for example, by an online service provider, which may provide computing services and digital products via one or more digital platforms, applications, websites, and the like. Service provider system 130 may provide computing services to various entities, which may implement security and fraud detection and prevention systems using an ML model pipeline to automate model training dataset and perform automated ML model training and solution generation, as discussed herein. In one example, service provider system 130 may be provided by PAYPAL®, Inc. of San Jose, CA, USA. However, in other embodiments, service provider system 130 may be maintained by or include another type of service provider.

Service provider system 130 of FIG. 1 includes an ML modeling platform 140, service applications 132, a database 136, and a network interface component 138. Service applications 132 and/or ML modeling platform 140 may correspond to executable processes, platforms, applications, and/or associated content and data with corresponding hardware. In other embodiments, service provider system 130 may include additional or different applications, platforms, and modules having corresponding hardware and/or software as required by their corresponding embodiments.

ML modeling platform 140 may correspond to one or more processes to execute modules and associated specialized hardware of service provider system 130 to provide an ML pipeline that may be used to detect fraudulent behavior and/or computing attacks, or perform other anomaly detection, based on anomalous signal detection, automated training data generation, and automated ML model training with solution generation using the ML pipeline discussed herein. In some embodiments, the ML modeling platform 140 may correspond to specialized hardware and/or software used for training and/or implementing ML models including NNs and other deep learning models for identification of behaviors, activities, patterns, or other signals of interest that indicate fraud, risk, malicious actions, computing attacks, or other anomalous signals. In this regard, ML pipeline may be used to perform inferencing and/or classification based on the ML models trained as described herein, for example, to provide risk and fraud detection services by service provider system 130.

Initially, ML modeling platform 140 may execute an auto-alert module 141 of the ML pipeline that may be configured to identify alert and/or anomalous signals from signals 122 detected, monitored, and/or tracked from signal sources 120. In this regard, auto-alert module 141 may perform alert signal detection or other anomalous signal detection using one or more ML models or other AI models, engines, and/or systems including rule-based AI engines, deep learning models, and the like. In some embodiments, alert signals are detected based on an ML model that does not require classification and may determine signals that indicate a threshold riskiness to qualify as an alert, or sufficiently out-of-line with a baseline or standard signal score/level to qualify as anomalous and therefore trigger an alert. A real-time alert detection may then be provided by auto-alert module 141 that may detect alerts for certain ones of signals 122 and/or anomalous signals of signals 122.

In addition to alert and/or anomalous signal detection, fluid segmentation may be used by auto-alert module 141 to classify alerts into groups or classifications, which may be further segmented into smaller groups depending on the desired population size. For example, where four metrics may be used for group classification by auto-alert module 141, ranked from one to four with one being the largest population size, if an alert group generated by auto-alert module 141 meets or exceeds a particular size, threshold, population size, or the like, the next metric that creates a smaller overall population group and/or alert population group may be used next to segment the alerts. This creates a segmented group or classification of alerts of a size that may be sufficiently useful for alert or anomalous detection of a particular behavior, activity, characteristic or other signal parameter or feature of interest. Analysis of signals 122 may be performed on a subset of the features or parameters of all features or parameters, such as those of interest for alert generation and flagging.

Once an alert signal group is identified by auto-alert module 141, an auto-root cause analysis (RCA) module 142 may perform an RCA of the alerts in the group to determine a riskiness of each alert, and whether the signal qualifies for training data selection and annotation usable to train an ML clustering model usable for an automated solution for the alerts and/or anomalous signals. Auto-RCA module 142 may utilize an RCA model 143 for determination of a root cause for each of the alerts, which may correspond to an unsupervised learning NN or another ML model. With an unsupervised learning NN, unsupervised training and learning may be performed using an unannotated data set, and as such, RCA model 143 may not require annotated data that may take time to mature and be annotated by a data scientist or other user using manual input and efforts. As such, RCA model 143 may be trained on all of the data features of signals 122 and may be trained to determine how risky each of the signals are, such as how far from the standard, baseline, or threshold for riskiness/safety of each of signals 122.

Auto-RCA module 142 may therefore identify a training data set by annotating the “risky” ones of signals 122. Risky may correspond to those ones of signals 122 that may be associated with fraud, ATOs, or other risky activity, behavior, or the like, such as transactions later flagged for fraud by a user, transactions occurring from an ATO, or the like, which can be categorized based on thresholds. Annotating the data for signals 122 may include flagging, tagging, or otherwise marking the ones of signals 122 meeting or exceeding the riskiness threshold with a tag indicating that those signals belong to the risky or fraudulent signal (e.g., transaction) group or classification. The “normal,” “not risky,” or valid/non-fraudulent signals (e.g., transactions) may also be sampled for the training data set, such as by taking a subset of those signals to be used with the risky or flagged signals during riskiness inferencing and/or model training.

Auto-solution module 144 may then train a classification ML model through one or more ML model clustering algorithms and/or techniques, or other ML model training algorithms and techniques including decision trees, NNs, deep learning, and the like. In this regard, ML modeling platform 140 may include a training and testing process, program, or application that may train clustering ML models and test for deployment. Clustering ML models may convert the training data to vectors and represent the vectors in a vector space, drawing relationships between similar vectors and/or vectors closeness or similarity in the vector space. As such, clusters may be created of vectors within a distance of each other, such as using Euclidean similarity and/or cosine similarity measurements, or other measurements of vector similarity and/or distance in a vector space. Clusters may have a cluster centroid and cluster distance from the centroid to the outer circumference of the cluster, where the cluster distance may represent the cluster size and/or cluster membership of different ones of signals 122, or other data points/records, in each cluster.

Solutions 145 may correspond to different executable decisions or actions that may be performed based on the clusters and/or cluster membership, such as a classification of the cluster and action to be taken when another signal, or other data point/record, is matched to that cluster (e.g., if the signal falls into the cluster when converted to a vector and placed or represented in the same or similar vector space). For example, with fraudulent transactions and/or accounts engaging in transaction processing, solutions 145 may include an account restriction on performing electronic transaction processing, declining the transaction and/or to process the transaction performed by the user or the account, or requiring an authentication to perform the processing of the transaction. Other types of solutions may also be provided. Once the clustering ML model has been trained, solutions 145 may be associated with different clusters, and a solution model 146 may be output by auto-solution module 144. Auto-solution module 144 may provide a custom configured and automatically generated solution to the alerts and/or anomalous signals without requiring user inputs and manual efforts to annotate and/or tag training data.

A mass action module 147 may then determine if solution model 146 may be applied to other areas, signals, and/or risk. For example, mass action module 147 may perform a group review by matching solution model 146 to different groups that utilize the same or similar signals, as well as providing solution model 146 for human review by the groups to determine applicability to other groups of signals and/or signal detection areas. An auto-summary module 148 may utilize a generative AI 149 to summarize the steps and operations used to generate solution model 146, including the alert or anomalous signals of signals 122 that led to the generation of solution model 146, for human review. In this regard, generative AI 149 may include a language model, such as an LLM, which may be configured to generate natural language text used to summarize the creation of solution model 146 by the ML model pipeline of ML modeling platform 140. Auto-summary module 148 may be configured to output the summary, as well as solution model 146 and/or one or more of solutions 145 configured to be executed and/or utilized when solution model 146 performs classification based on clustering and/or other similarity techniques. The summary and additional information for signals 122, the solution, and the like may be output via a GUI, which may further present the information with any other relevant metric, analytic, or additional data that may assist a user when reviewing and/or determining the accuracy of solution model 146 or other ML model.

In various embodiments, auto-summary module 148 may provide a text, graphical, and/or other explainable representation of the training of solution model 146 based on those of signals 122 used for model training. The summary from auto-summary module 148 may include a data quality assurance (QA) report, a performance of the solution, a loss capture rate, an accuracy of the solution when applied to additional alert signals, or one or more communications associated with identifying occurrences of the risk activity corresponding to the alert and/or anomalous signals. If solution model 146 is implemented in an AI system, such as a risk and/or fraud detection system used by service applications 132, solution model 146 may be implemented in and/or with ML models 134 utilized and/or executed by service applications 132.

ML models 134 may correspond to and/or provide classifiers configured to classify signals, such as transactions and/or account activities, as fraudulent (e.g., fraud, ATO transaction, etc.), risky, engaging in a computing attack or malicious behavior, or likely to do so and/or be associated with such behavior. Auto-solution module 144, or another component of the ML pipeline provided by ML modeling platform 140, may train ML models 134 for service applications 132 using the training data automatically generated and/or determined in the manner discussed herein. ML models 134 may include and/or correspond to different types of ML models (clustering, decision trees, NNs, DNNs, LLMs and other generative AIs). ML models 134 may have trained layers based on training data and selected features or data variables configured for alert and/or anomalous signal detection and classification. For example, ML features or variables may correspond to individual pieces, properties, characteristics, or other inputs for an ML model and may be used to cause an output by that ML model once the ML model has been trained using data for those features from training data. ML models 134 may be used for computation and calculation of model scores based on layers, nodes, branches, clusters, rules, and the like that are trained and optimized. As such, ML models 134 may be trained to provide a predictive output, such as a score, likelihood, probability, or decision, associated with a particular prediction, classification, or categorization.

ML models 134 may include DNNs, ML clustering or decision tree models, LLMs, generative AIs, or other AI models trained using training data having data records that have columns or other data representations and stored data values (e.g., in rows for OCP. the data tables having feature columns) for the features. When building ML models 134, training data may be used to generate one or more classifiers and provide recommendations, predictions, or other outputs based on those classifications and an ML or NN model algorithm and architecture. The algorithm and architecture for the ML models 134 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different output value based on the input values. The values generated by the hidden layer nodes may be used by the output layer node(s) to produce one or more output values for ML models that attempt to classify and/or categorize the input feature data and/or data records. Thus, when ML models 134 are used to perform a predictive analysis and output, the input data may provide a corresponding output based on the trained classifications.

Layers, branches, clusters, or the like of ML models 134 may be trained by using training data associated with data records of interest including one or more of signals 122. By providing training data, the nodes in the hidden layer may be trained (adjusted) such that an optimal output (e.g., a classification) is produced in the output layer based on the training data. By continuously providing different sets of training data and/or penalizing ML models 134 when the outputs are incorrect, ML models 134 (and specifically, the representations of the nodes in the hidden layer) may be trained (adjusted) to improve its performance in data classifications and predictions. Adjusting of the ML models 134 may include adjusting the weights associated with each node in the hidden layer.

Service applications 132 may correspond to one or more processes to execute modules and associated specialized hardware of service provider system 130 to process a transaction and/or provide other computing services to users. For example, service applications 132 may be used to process payments and other services to one or more users, merchants, and/or other entities for transactions, where use of those services, applications, websites, data, and the like may include use of ML models 134 for predictive inferencing and/or other outputs including fraud detection and/or computing attack mitigation. In this regard, users, including merchants and other entities, as well as customers and individual users, may establish a digital account for engagement with the products and services of service provider system 130. For example, the account may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 132 may process payments and may provide transaction histories to client device 110 and/or another user's device or account for transaction authorization, approval, or denial of the transaction for placement and/or release of the funds, including transfer of the funds between accounts based on compliance investigations.

In further embodiments, service applications 132 may provide different computing services to users and entities, including social networking, microblogging, media sharing, messaging, business and consumer platforms, etc. Use of the computing services may require use of ML models 134, such as those for fraud detection and/or risk assessment. As such, service applications 132 may be integrated with ML modeling platform 140 for use and/or deployment of ML models 134 once trained. For example, accounts may utilize service applications 132 to engage in different account activities, such as electronic transaction processing requests. Signals 122 may be exchanged during transaction processing, as well as for service, assistance, or the like. Fraud or other classification scores may be determined based on signals 122, which may be used to execute solutions that are performed to properly handle risky, fraudulent, or otherwise classified signals and/or transactions.

Service applications 132 may also provide additional features to service provider system 130. For example, service applications 132 may include security applications for implementing server-side security features, programmatic client applications for interfacing with appropriate APIs over network 150, or other types of applications. Service applications 132 may contain software programs, executable by a processor, including one or more GUIs and the like, configured to provide an interface to the user when accessing service provider system 130, where the user or other users may interact with the GUI to view and communicate information more easily. Service applications 132 may include additional connection and/or communication applications, which may be utilized to communicate information to over network 150.

Additionally, service provider system 130 includes or may access database 136. Database 136 may store various identifiers associated with client device 110, as well as account data, including payment instruments, financial information, account balances, and authentication credentials, as well as transaction processing histories and data for processed transactions. Database 136 may include information for accounts and/or transactions, including signals 122 where logged and used for later analysis and ML modeling. Although database 136 is shown as residing on service provider system 130 as a database, in other embodiments, other types of data storage and components may be used including cloud computing storage nodes, remote data stores and database systems, distributed database systems over network 150 and/or of a computing system associated with service provider system 130, and the like.

Service provider system 130 may include at least one network interface component 138 adapted to communicate client device 110, signal sources 120, and/or other devices and servers over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

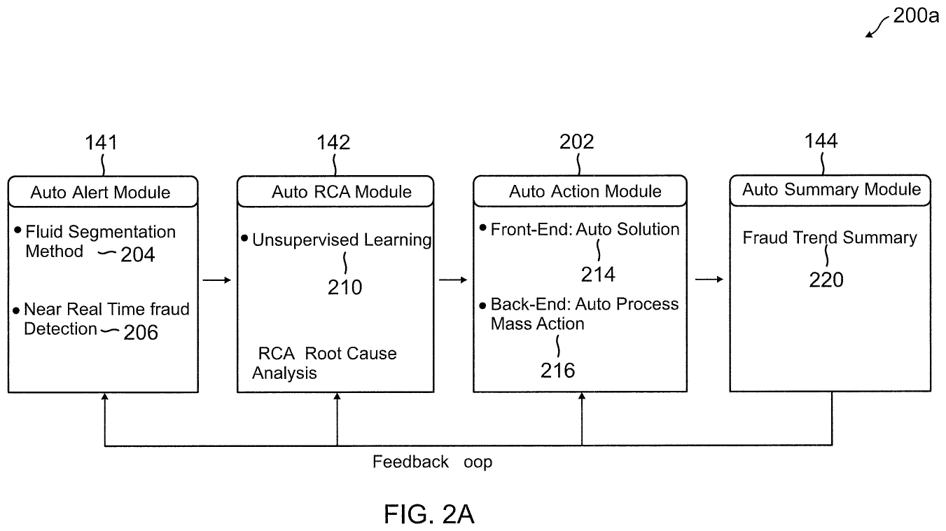

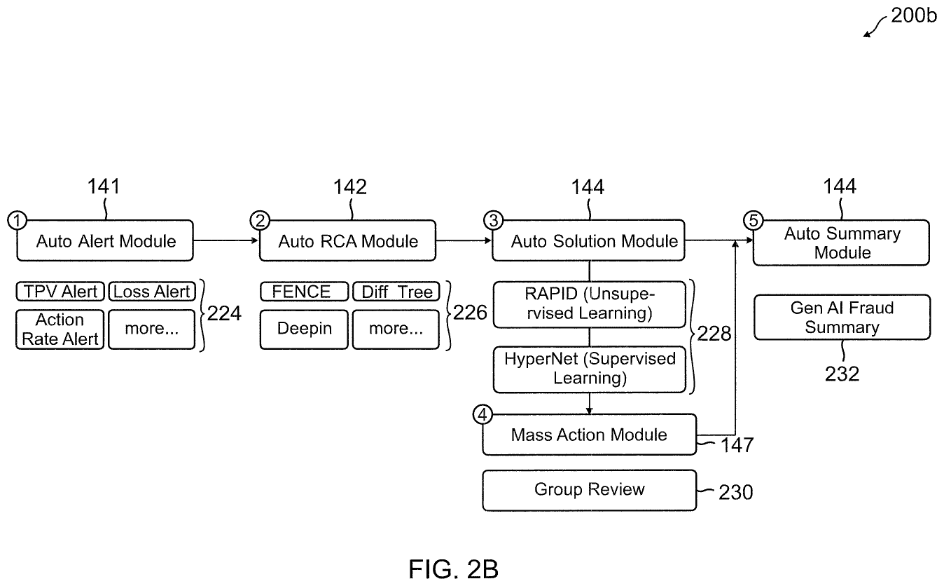

FIGS. 2A and 2B are exemplary diagrams 200a and 200b of a system pipeline implementing an auto-alert, auto-root cause analysis, auto-solution and/or auto-action or mass action, and auto-summary modules, according to an embodiment. Diagram 200a shows representations of the components, data, and calls of ML pipeline of ML modeling platform 140 for service provider system 130, discussed in reference to system 100 of FIG. 1. In this regard, a flow between the components of ML modeling platform 140 is shown in diagram 200a, with further detail to the sub-components of each individual component on ML modeling platform 140 shown in further detail in diagram 200b.

In diagram 200a of FIG. 2A, auto-alert module 141, auto-RCA module 142, an auto-action module 202 (e.g., a combination of auto-solution module 144 and mass action module 147 with optional engines, platforms, and/or applications to execute the action and other solutions determined by auto-solution module 144), and auto-summary module 144 are shown in further detail. In this regard, auto-alert module 141, auto-RCA module 142, auto-action module 202, and auto-summary module 144 correspond to components of ML modeling platform 140 and may be used to automate generation of a solution to a risk activity that has been detected and identified in computer, network, or other signals. The data may also be detected in data records for these signals, communications, operation events or processes, other data including network traffic logs, computer or operating system logs, firewall logs, and other computing logs. Consequently, auto-alert module 141, auto-RCA module 142, auto-action module 202, and auto-summary module 144 may be used to identify risk, fraud, whether a computing attack is being performed, an ATO or other activity that compromises an account, private or privacy protected user data, and the like. This may be done through automated training data generation, model training and deployment, and solution selection using the ML models and processes discussed herein.

In this regard, auto-alert module 131 may include or perform a fluid segmentation method 204, or other segmentation process, to segment alerts as the alerts are detected and/or received into multiple different segments depending on the metric of interest. For example, for a domain for network traffic or activities associated with online transaction processing, transaction signals or other data records may be segmented by region, age, traffic type or time, or the like, which may lead to different size groups of the signal population overall, as well as different sizes and distributions of the alert signals or transactions. Segmenting of signals 122 by region may exclude all other regions, and therefore the population of non-alert and alert signals may be significantly reduced. Because of the nature of fraud and/or risk, different segments may also have different distributions and/or percentages of alerts within the segments. Segmenting by an age group of 18-36 may yield a different percentage of alerts overall than by region or by another age group. As such, fluid segmentation method 204 may be implemented with and/or work in conjunction with a near real-time fraud detection 206 to segment the signals so that an alert signal group of an appropriate and/or selected fill size for training data generation and/or model training is obtained. Further, a feedback loop 208 may provide feedback from domain owners or administrators, which may be used to adjust and/or reconfigure fluid segmentation method 204 and/or near real-time fraud detection 206, such as based on correctly or incorrectly flagged transaction, fill size for fluid segmentation selection of a segment, and the like.

Near real-time fraud detection 206 may be performed using an ML model that may initially predict what signals to provide alerts on, such as what transactions to flag for a further review and/or indicate as suspicious, which may generate an alert signal for use transactions. Auto-alert module 141 may generate an initial data set of flagged and unflagged signals or other data records, which may then be provided to auto-RCA module 142 that utilizes an unsupervised learning 210 to predict riskiness of each alert signal, as well as the appropriate next action to take (e.g., based on the riskiness, whether the next action should be more or less restrictive, punitive, or severe). Riskiness may be determined by unsupervised learning 210 using an unsupervised learning ML model, such as by determining a score and/or severity level or threshold of the flagged (or unflagged, when applicable) signal, and correlating that score or severity to a corresponding punitive, corrective, or preventative action to take.

Auto-action module 202 may correspond to a module that includes both auto-solution module 144 and mass action module 147, and may further include or perform one or more operations that cause performance and/or execution of a remedial and/or proactive action, operation, or other solution-based activity to prevent, reduce, and/or repair fraud and/or harm caused by a malicious entity, computing attack, ATO, misappropriated data, or the like. In this regard, auto-action module 202 may include a front-end auto-solution 214 that may include solution model 146 with one or more of solutions 145. Solution model 146 may correspond to an ML clustering model; however, other types of ML processes, techniques, and model may be used including decision trees, NNs, LLMs and other generative AIs, and the like. As such, solution model 146 may be designed to generate alerts on and detect different types of risk activities and/or frauds, or other signals of interest, and may assign different classifications, which may be associated with execution of different ones of solutions 145.

Additionally, a back-end auto-mass action process 216 of auto-action module 202 may perform mass action linking and/or expanding of front-end auto-solution 214 to other environments, domains, tasks, and the like so that the solution and corresponding model may be expanded and applied to other areas where similar predictive services may be used to reduce, eliminate, or proactively identify fraud and/or potential fraud. Auto-summary module 114 may then provide an output summary of the operations, training, and deployment of solution model 146 to the corresponding domain, environment, and task to which the model is to perform predictive risk analysis and solution execution. A fraud trend summary 220 may include the aforementioned information regarding the development of solution model 146, as well as information about the fraud trend or other pattern in signals that was investigated and used to train the AI model for detection and solution execution.

In this regard, generative AI 149 of auto-summary module 148 may generate fraud trend summary 220 based on input associated with the operations of auto-alert module 141, auto-RCA module 142, auto-action module 202, and/or any other modules, processes, applications, or platforms involved in model training, training data development, solution selection and/or execution, and the like. Generative AI 149 may be prompted based on the results from each step to understand such results and provide a summary. This allows for a data scientist, system administrator, or another user to review the model's development and deployment to determine applicability, issues, results, and the like.

Referring now to FIG. 2B, in diagram 200b, components of each of auto-alert module 141, auto-RCA module 142, auto-action module 202, and/or auto-summary module 144 are shown. Diagram 200b shows representations of different sub-components within each component of ML modeling platform 140. For example, auto-alert components 224 for auto-alert module 141 may include a total payment volume (TPV) alert, a loss alert, an action rate alert, and additional alerts. Auto-alert components 224 may include different types of alert components, such as different alert ML models or other AI models and engines, that may provide alerts on different types of signals. For example, signals may correspond to transaction data and/or transaction requests, or other data that may be transmitted with, utilized when processing, or otherwise associated with information for a user, device, entity, account, network address, financial or any other identification data. The data may also correspond to account data assets, such as a phone number, credit card, email, driver's license, passport, bank account, a virtual identity identifier, a device identifier, an IP address, financial data, PII, known your customer (KYC) data, and the like. Auto-alert components 224 may include or generate near real-time (NRT) alerts to speed up any trend detection time before bad tags by manual efforts and utilized and come online.

Auto-RCA module 142 may include auto-RCA components 226, which may contain a fraud early notification and counter engine (FENCE), decision (diff) trees, deep learning (deepln), and the like, which may be used to fully automate processes for analysis of root causes of alerts, which may leverage unsupervised learning to determine a riskiness of an event. The RCA may be performed on or for a set of alerts or other anomalous signals, and may assess the riskiness of each signal, such as each transaction. Further, the riskiness may also be analyzed or set for the non-risky transactions or other signals, or a sampling of, for system configurations. Auto-solution module 114 may include auto-solution components 228 including a near real-time anomaly detection solution with unsupervised learning methods (RAPID), which may correspond to an unsupervised learning ML clustering model. The ML clustering model may be unsupervised because the training data, which may have been annotated by results of FENCE from auto-RCA module 142 but in an automated and machine-or computer-driven and executed manner, without or independent of user inputs and/or other manual efforts by a human user. As such, human inputs and interactions are not needed for training, and the training data remains unannotated and unsupervised by a human agent, reviewer, developer, or other user. RAPID may provide an unsupervised learning algorithm to generate solutions automatically, which may utilize a config channel and/or mini model.

A supervised learning technique, such as HyperNet (e.g., Hypernetworks, or NNs that generate weights for a main NN), may also be used to provide supervised learning on annotated data signals or other data records, as well as weights to a NN or other ML model generated by RAPID or other ML process. This may provide a secondary model training and/or comparison between models for different training, for example, if the training data annotated by a machine is further utilized for supervised learning using HyperNet or the like, or another later annotated data set is used when tagging becomes available or is performed. Mass action module 147 may include mass action components 230, such as a group review process, where a solution may be applied to other technologies and/or technical fields. Mass action may correspond to one of the risk mitigation solutions enabled through group review of detection mechanisms and automatically generated solutions. Mass action may help extend the risk coverage of existing and/or automatically generated detection models and mechanisms, as well as their corresponding solutions, by proactively exploring the linking between accounts and identifying group of fraudsters. However, in the context of the ML pipeline for automated solution generation, the full real-time capabilities may be realized and achieved without using or providing mass action module 147 and/or a mass action review and solution.

The solutions applied may correspond to fraud or risk mitigation actions that may be taken. Fraud or risk mitigation actions may include terminating the transaction and/or showing an alert to a user, merchant, agent, etc., adding patterns or content to a dashboard for tracking the trends, or performing another action to mitigate the risk and fraud including notifying security systems, banning accounts or blocking communications, and the like. For example, an identification challenge may require a user to provide identification or verification information or complete a challenge-response test to detect if the account is being used by a human user. A challenge-response test may correspond to a CAPTCHA test or similar test, query, question, or request that may be configured to detect human users from bots.

Auto-summary module 144 may include auto-summary components 232, such as a generative AI that may generate a generative AI summary. The generative AI may correspond to an LLM or other language model that may generate output text from input data with a prompt. A prompt, or an LLM prompt, may correspond for explicit instructions, readable and processable by a corresponding LLM, that cause the LLM to provide a response based on that instruction, such as perform a specific processing task, find certain data, executing certain ML models (e.g., the trained model of solution model 146. Thus, the LLM may be instructed via the prompt to provide a response in natural language that summarizes the steps of ML modeling platform 140 that generate, deploy, and/or detect fraud or other anomalous signals using the ML clustering model or other procedurally generated model (e.g., generated according to the procedures and steps of ML modeling platform 140 discussed herein).

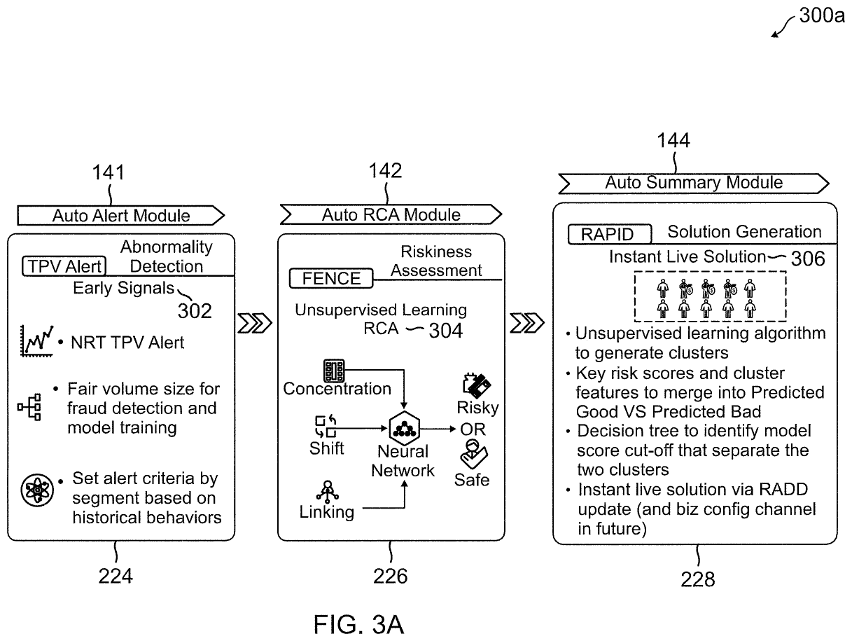

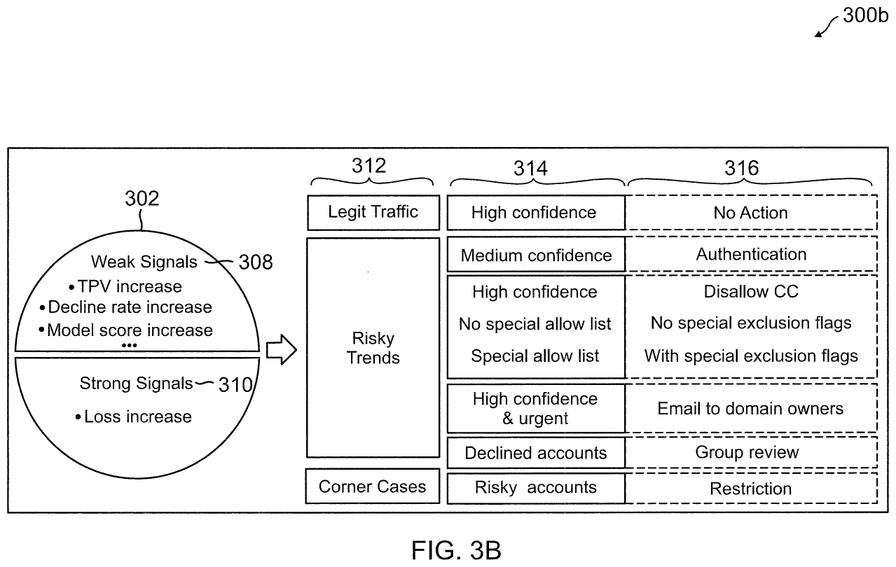

FIGS. 3A and 3B are exemplary diagrams 300a and 300b of data and operations used to process the data of the auto-alert, auto-root cause analysis, and auto-summary modules, according to an embodiment. Diagrams 300a and 300b of FIGS. 3A and 3B include modules and components discussed in reference to ML modeling platform 140 for service provider system 130 from system 100 of FIG. 1. Diagram 300a shows three different AI models and/or techniques of three different modules or components of ML modeling platform 140, auto-alert module 141, auto-RCA module 142, and auto-solution module 144. Diagram 300b shows the determinations, predictions, inferences, or other outputs of each of these models when executed and utilized with anomalous signal detection, such as for risk and/or fraud detection.

In diagram 300a, auto-alert module 141 may detect early signals 302 using an alert ML model, which may be done using an NRT TPV alert, and may require detection of a certain number, percentage/ratio, volume size (as compared to all signals detected and/or transmitted) of anomalous signals for fraud detection and model training. This means that a sufficient fill size of anomalous or other alert signals may be required to be detected, and alert criteria may be set by segment based on historical behaviors. Auto-RCA module 142 utilizes an unsupervised learning RCA model 304, which may correspond to an ML model, such as a NN, that may identify signals as risky or safe, thereby annotating the signals based on a root cause determination from the analysis. Lastly in diagram 300a, auto-solution module 144 may generate an instant live solution 306 using a RAPID model training and learning technique, where an unsupervised algorithm generates clusters or like or similar signals, keys risk scores and cluster features to those clusters to predict good and bad clusters, as well as their scale or classification within a scale of good to bad or vice versa, such as high risk to low risk, with one or more intermediary risk designations. Decision trees may be used to identify a model's core cut-off that separates the two clusters and instant live solutions via Risk Analytics Dynamic Data (RADD) may update and deploy the solution. RADD may correspond to a data channel in which data is pushed from an offline storage service and/or other offline computing service or system (e.g., Teradata, Hadoop, Big Query, etc.) to online computing services.

Referring now to FIG. 3B, in diagram 300b, early signals 302 may be split into weak signals 308 (e.g., TPV increase, decline rate increase, model score increase, etc.) and strong signals 310 (e.g., loss increase). Early signals 302 may initially be detected as causing an alert by the alert ML model of auto-alert module 141, which then generates the alerts only on a subset of the features used for RCA. Therefore, the alert model may not tag the transactions as a full analysis for the root cause may be required by auto-RCA module 142. The alert model may instead pass the signals, including nonfraudulent signals and/or signals identified as risky or anomalous, to auto-RCA module 142, which may then classify the signals according to three types of classifiers shown in diagram 300b, although more, less, or other classifiers may also be used. For example, classifiers 312, 314, and 316 may be used to classify the signals according to their traffic type, confidence or likelihood of fraud, and action to be taken (e.g., solution to be implemented based on the solutions utilized for the fraud or other anomalous behavior pattern. As such, traffic classifier 312 is shown with classifier values including legit traffic, risky trends and/or corner cases. Fraud confidence classifier 314 includes different confidences in an account's legitimacy and/or legitimacy of an activity, action, or behavior engaged in by the account, such as high confidence, medium confidence, high confidence with a special allow list of activities, actions, or behaviors, etc. Solution classifier 316 then seeks to classify a solution to the detected signal and the legitimacy of that signal, which may be used for automated solution execution and fraud confidence classifier 316.

Auto-RCA module 142 may determine traffic classifier 312 and fraud confidence classifier 314 when classifying each of the signals initially detected and/or alerted on from early signals 302. For example, traffic classifier 312 may identify the traffic (e.g., network traffic, such as from a network traffic log of network communications) as legitimate traffic, risky trends, and/or corner cases), where each of traffic classifier 312 may further be split by their confidence value for an execution of the corresponding solution identified by solution classifier 316 (e.g., to take no action with regard to the signal and/or transaction, require authentication, disallow the credit card (CC), email the domain owners, perform a group review, and/or issue or implement a restriction. As such, each particular value or “solution” designated for a signal by solution classifier 316 may correspond to an action, operation, task, activity, or the like performed with a computing device, account, user (via their device/account/etc.), and/or network traffic that may be responsive to the assessed and/or identified risk or fraud. For example, the solutions identified by solution classifier 316 may be responsive to identifying network traffic having a risk or fraud score falling into one of fraud confidence classifiers 314, such as a range of risk scores that may be associated with a corresponding riskiness (e.g., low risk being identified with a low range of scores where the higher the score, the riskier the corresponding signal is). In such an embodiment, as risk scores go up, so does corresponding riskiness, and a higher range of scores may be associated with high risk.

As such, the solutions identified by solution classifier 316 may correspond to those executable actions, and may include no action, that may be performed to reduce, mitigate, or reverse harm caused by risk and fraud. These actions may include requiring an authentication of a user and/or account, disallowing a credit card use with either no special exclusion flags or a special exclusion flag, email to a domain owner, a group review of the signal(s), and/or implementing a restriction. The restriction may be implemented against transaction processing, an account, a device, a user (identified by a one or more names, identifiers, devices, etc.), a transaction, or other users, entities, and/or activities. Thus, diagram 300b may be used for action execution after processing new incoming signals by solution model 146, or other ML model, NN, or the like trained based on the procedurally generated training data, as discussed herein.

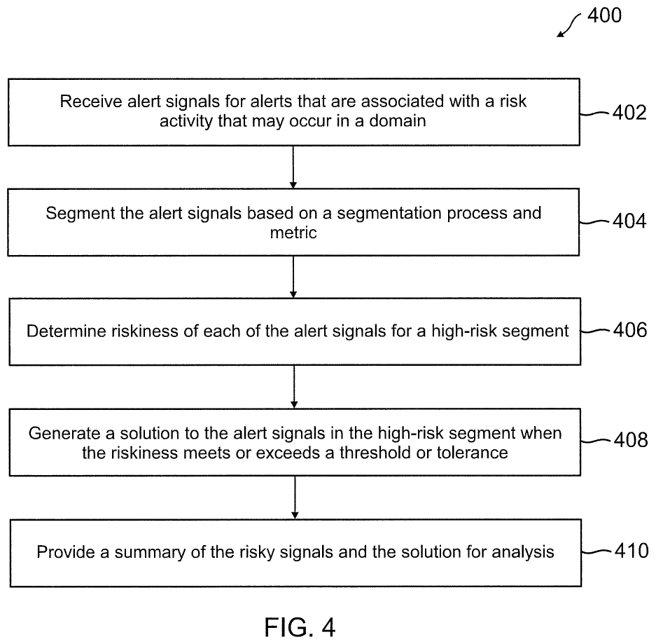

FIG. 4 is a flowchart 400 for a deep learning pipeline for proactive identification and mitigation of computing system attacks from social engineering, according to an embodiment. Note that one or more steps, processes, and methods described herein of flowchart 400 may be omitted, performed in a different sequence, or combined as desired or appropriate.

At step 402 of flowchart 400, alert signals are received for alerts that are associated with a risk activity that may occur in a domain. Service provider system 130 may receive signals 122 via one or more communication channels, through streaming data, and/or through aggregations of signals 122 and transmission of batches or data sets of signals 122 for processing. Signals 122 may require risk and/or fraud analysis and detection to prevent or mitigate fraud, computing attacks, and other malicious behaviors that may be the result of new and/or ongoing fraud patterns, behaviors, activities, or other courses of action. In this regard, signals may include data, content (e.g., messages, endpoints, timestamps, activities, etc.) that may be analyzed for fraudulent conduct, and two or more of signals 122 may be required to be combined when analyzing for patterns indicating malicious activities or other conduct.

Auto-alert module 141 may process signals 122 for the initial alerts based on an auto-alert generation model, such as an ML model configured to automatically generate alerts and/or flag certain ones of signals 122 with an alert based on those signals being anomalous or otherwise indicative of an alert. While flagging may occur, the data records for signals 122 that produce alerts by the alert generation model may not be annotated as the model may be only trained on a set of features and not all features of the indicative risky or fraudulent activity. As such, only an initial alert of the signal/data record may be generated, and the flag may indicate further review is necessary. Signals 122 may correspond to a specific domain, such as a region, location, demographic of users, type of activity, type of communication and/or communication channel used, or the like, and as such, the domain may have different metrics by which signals 122 may be split into groups so that a sample size of fraudulent or other risky activities may be identified, and a fill size may be met for suspicious, risky, and/or fraudulent activity. For example, the metrics for a domain associated with online transaction payment requests may include metrics for country, age, traffic type, etc., by which segmentation into high/low risk, flagged or not flagged, or other initial risk analysis may be performed.

At step 404, the alert signals are segmented based on a segmentation process and metric. Auto-alert module 141 for ML modeling platform 140 may segment signals 122 for a particular domain by a fluid segmentation process so that an analysis of a root cause for each flagged signal may be further performed. In this regard, segmentation may include a process by which those of signals 122 for a particular domain and/or risk solution generation may be segmented. Segmented portions may be a subset of all of signals 122 for the particular domain, and segmentation may be performed to ensure a proper fill size of the potentially risky or fraudulent transactions is met and/or is not exceed. Fluid segmentation may proceed through a list, selection, or determination of different populations and/or metrics of signals 122 to segment from all of signals 122.

Segmentation may be performed based on the fill size, so that if the fill size for the flagged or identified population does not meet, or instead, does exceed, a threshold amount, a next segmentation metric may instead be used. Once segmented, the flagged and/or identified signals (e.g., those that have been automatically alerted on by the initial alert generation model) in that segment may be determined from the non-flagged (e.g., non-fraudulent), as discussed below with regard to step 406. However, segmentation may be performed to ensure a proper fill size is met and the training data group does not have too many or too few flagged, annotated, or otherwise identified ones of signals 122, or other data records. As such, after step 404 if the fill size is not meet, or is exceed (which may include falling into a percentage or numerical threshold range), then step 404 may be repeated for segmenting by another metric of the population of signals 122 for the domain.

At step 406, riskiness of each of the alert signals is determined for a high-risk segment, such as a segment of the alert signals that initially are identified with a high likelihood of fraud, as anomalous, or as otherwise being flagged for further review. After segmenting signals 122 using the fluid segmentation process or other segmentation process and metric, auto-RCA module 142 may then utilize RCA model 143 to determine a root cause and a riskiness of each of signals 122. In this regard, RCA model 143 may be used to predict a root cause of the anomalous signal indication, such as a prediction, analysis, or determination that the signal was flagged based on a high likelihood of fraud, misuse of stolen payment information and/or credentials, or other root cause that may indicate that the signal is associated with a transaction, user, entity, or the like that meets or exceeds a threshold riskiness. Signals may have their predicted root cause determined by RCA model 143, such as fraud, accident or incidental activity that may indicate fraud but not perpetrate fraud, or valid/non-fraudulent. Other classifiers and/or categorizations may also be used.

RCA model 143 may then provide each user, the requester, or other party utilizing ML modeling platform 140 to perform an analysis and annotation of signals 122. Once labels or tags are determined, RCA model 143 may annotate a subset of signals 122 that are anomalous or indicative of fraud or other risky or malicious activity. RCA model 143 may be used to determine a riskiness of each of the alert signals, as well as any other signals in the segmented population of alerts 122, to determine whether the signals should be annotated and what the label or tag for annotation may be.

At step 408, a solution to the alert signals in the high-risk segment is generated when the riskiness meets or exceeds a threshold or tolerance. Once training data has been generated by auto-RCA module 142 using RCA model 143, the training data may be used at step 408 by auto-solution module 144 to generate solution model 146, which may be used to enforce one or more of solutions 145 on further, future, or additional signals, data records, and/or the like, as well as users, accounts or devices associated with those signals, data records, etc., when they are detected by solution model 146. Solution model 146 may correspond to a clustering ML model, and may generate clusters of signals 122, or their corresponding data records and/or vectors in a vector space of n-dimensionality (where n may correspond to a number of features of the vectors or other value or combination of values determined for the vector by an encoding and/or embedding algorithm), so that inferences may be drawn and/or determined for vectors in the same cluster and/or matched to a cluster (e.g., within a distance d of a centroid c of a cluster, where the d represents cluster membership of those vectors having a similarity distance or score less than and/or equal to d, and c represents a point in the vector space). The inferences may correspond to predictions or classifications, such as high-risk, low-risk, medium-risk, or other risk and/or fraud classification. Thus, the clustering model may be used to classify further signals and/or data records, once converted to, and/or embedded/encoded as, vectors, based on the cluster to which they belong and the classification of cluster members in that cluster.

At step 410, a summary of the risky signals and the solution is provided for analysis. Once solution model 146 is generated, as well as mass action module 147 applied to extend solution model 146 to other areas or domains to which it may be applicable, auto-summary module 148 may utilize generative AI 149 to generate one or more summaries of steps 402-408 and their performance by ML modeling platform 140. The summary may explain each step taken and the data processing, predictions, inferences, or the like made at each step, so that a user may review the summary and determine how solution model 146 was trained and applied to a particular risk activity and/or classification task. Generative AI 149 may correspond to an LLM or other language model that may generate the summary in natural language text so that the summary may be readable, and may provide the summary to one or more user endpoints that may allow for reviewing and auditing of solution model 146 for deployment and further use, as well as ML model platform 140 for performance, accuracy, effectiveness, or other performance metric.

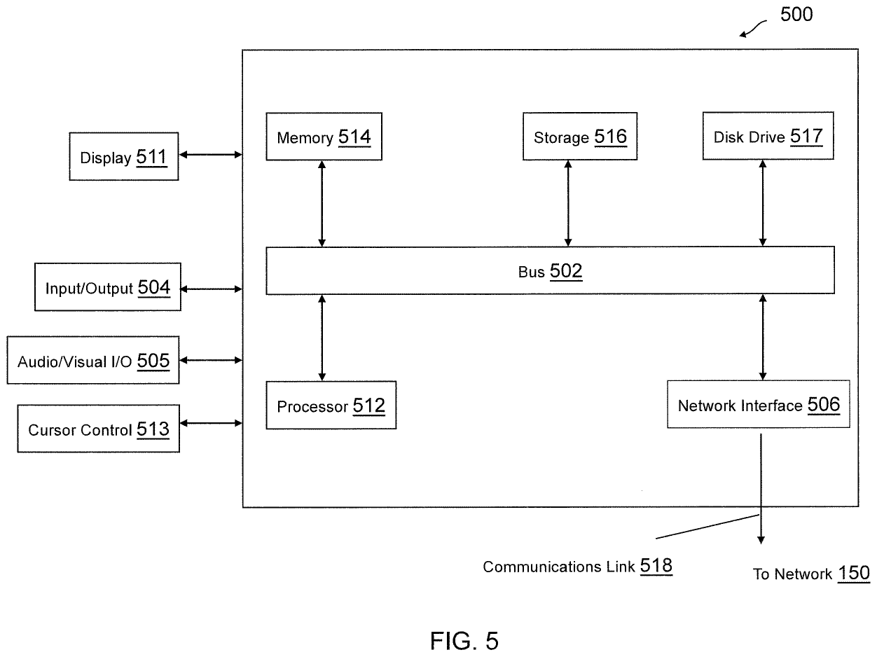

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a plurality of alert signals associated with a risk activity in a domain at a machine learning (ML) modeling platform for an ML pipeline;
segmenting a set of alert signals for the plurality of alert signals using an automated segmentation process and based on a plurality of segment metrics and a fill size for a segment of a user population that is associated with the set of alert signals;
predicting a risk score for each signal in the set of alert signals using a first ML model of the ML pipeline that is trained using unsupervised learning from unlabeled signals in the domain;
determining that the risk score for one or more signals in the set of alert signals meets or exceeds a threshold risk of identifying the risk activity using a root cause analysis of the ML pipeline;
generating, using a second ML model of the ML pipeline that is trained for ML clustering and model training on clusters, a risk activity solution associated with the one or more signals based on at least one of the risk score, the threshold risk, or the root cause analysis, wherein the risk activity solution comprises using a clustering ML model and an automated task that when executed mitigates an effect of the risk activity on the domain;
generating a summary of the risk activity solution and data for the risk activity that causes the risk score for the one or more signals to meet or exceed the threshold risk using a generative artificial intelligence (AI) of the ML modeling platform; and
outputting the risk activity solution and the summary via a graphic user interface (GUI) of the ML modeling platform.

2. The method of claim 1, wherein the automated segmentation process comprises a fluid segmentation operation that segments the plurality of alert signals into the set of alert signals, wherein the fluid segmentation process further segments different sets of the plurality of alert signals based on a plurality of fill metrics for segmenting the user population by different features.

3. The method of claim 2, wherein prior to the receiving the plurality of alert signals, the method further comprises:
collecting data associated with the plurality of alert signals from a plurality of sources associated with the domain;
filtering the data for the plurality of alert signals based on one or more indicators of the risk activity; and
identifying the plurality of alert signals that are associated with the risk activity based on the filtering.

4. The method of claim 1, further comprising:
receiving feedback for at least one of the risk activity solution or the summary; and
updating one or more ML models of the ML pipeline based on the feedback.

5. The method of claim 4, wherein the feedback comprises at least one of a data quality assurance (QA) report, a performance of the risk activity solution, a loss capture rate, an accuracy of the risk activity solution when applied to one or more additional alert signals to mitigate the risk activity, or one or more communications transmitted or received by a system associated with identifying occurrences of the risk activity.

6. The method of claim 1, further comprising:
providing a tool that enables at least one of reviewing the risk activity solution and the summary, changing or disabling the risk activity solution, or taking additional actions as a result of implementing the risk activity solution in the domain for the risk activity.

7. The method of claim 1, wherein the first AI model comprises an automated root cause analysis (RCA) model trained based on unsupervised learning of signal riskiness for additional signals in the domain.

8. The method of claim 1, further comprising:
determining a riskiness classification of the set of the alert signals based on the risk score for the one or more signals in the set;
determining a plurality of solutions available for use with the domain to mitigate the risk activity; and
selecting the risk activity solution from the plurality of solutions based on the riskiness classification and a criterion for solution selection associated with the domain.

9. The method of claim 8, wherein the plurality of solutions includes at least one of an account restriction, declining one or more activities performed by a user or an account, or requiring an authentication by the user or of the account of the one or more activities.

10. A system comprising:
a non-transitory memory; and
one or more hardware processors coupled to the non-transitory memory and configured to execute instructions to cause the system to:
predict a plurality of risk scores associated with a plurality of alert signals using a first machine learning (ML) model;
determine that one of more of the plurality of risk scores indicate a risk activity associated with one or more of the plurality of alert signals using a second ML model;
generating a third ML model that clusters the one or more of the plurality of alert signals, wherein an output of the third ML model is associated with a performance of a solution for the risk activity when the one or more of the plurality of alert signals are detected based on the one or more of the plurality of risk scores, wherein the solution comprises an automated task that mitigates an effect of the risk activity;
generate a summary of the solution using a generative artificial intelligence (AI); and
output the solution via a graphic user interface (GUI).

11. The system of claim 10, wherein the first ML model is trained using unsupervised learning, and wherein the first ML model is further trained based on training data comprising suspicious signals or anomalous signals that are unlabeled by human review.

12. The system of claim 10, wherein, prior to predicting the plurality of risk scores, executing the instructions further causes the system to:
receive data signals including the plurality of alert signals associated with the risk activity in a domain.

13. The system of claim 10, wherein, after predicting the plurality of risk scores, executing the instructions further causes the system to:
segment the plurality of alert signals from a population of alert signals received in a domain over a time period using an automated segmentation process.

14. The system of claim 13, wherein the automated segmentation process comprises a fluid segmentation process, and wherein the fluid segmentation process is configured to segment the plurality of alert signals based different features of users associated with the population of alert signals.

15. The system of claim 10, wherein the third ML model comprises a clustering ML model trained based on a plurality of clusters of the plurality of alert signals and a corresponding classification for each of the plurality of clusters.

16. The system of claim 14, wherein the corresponding classification for each of the plurality of clusters is determined based on the plurality of risk scores and riskiness of score ranges for the plurality of risk scores.

17. The system of claim 10, wherein the plurality of alert signals comprises transaction processing signals received in a transaction processing domain of a service provider.

18. A non-transitory machine-readable medium having stored thereon machine-readable instructions executable to cause a machine to perform operations comprising:
determining, for a set of signals from a plurality of signal sources for a domain, one or more risk scores associated with one or more signals in the set correctly identifying a root cause of an alert associated with the one or more signals using a machine learning (ML) system comprising a plurality of unsupervised ML models trained using unlabeled data associated with one or more causes of one or more alerts in the domain;
performing a root cause analysis of the set of the signals based on the one or more risk scores, wherein performing the root cause analysis determines, using a first unsupervised ML model of the ML system, whether the one or more risk scores indicate that the one or more signals in the set are indicative of the root cause;
based on the root cause analysis indicating that the one or more signals in the set identify the root cause correctly, predicting, using a second unsupervised ML model of the ML system, a solution to the root cause, wherein the solution comprises an executable task that prevents or reduces a loss caused in the domain by the root cause, and wherein the solution is one of a plurality of solutions for different ML clusters identified by the second ML model;
determining whether the solution can be extended to an additional set of the signals that identify another root cause having a risk associated with one or more of the additional set; and
generating, using a generative artificial intelligence (AI) of the ML system, a summary of the solution and data used for the root cause analysis.

19. The non-transitory machine-readable medium of claim 18, wherein predicting the solution comprises generating a clustering ML model based on the set of signals and the one or more risk scores, wherein the clustering ML model comprises a plurality of clusters that each have a corresponding classification of additional signals correlated to the plurality of clusters.

20. The non-transitory machine-readable medium of claim 18, wherein the set of signals are associated with a set of transactions, and wherein the plurality of signal sources comprises transaction requesters including at least one of a customer, a merchant, or an electronic transaction processing service.
